(19) United States
(12) Patent Application Publication
(10) Pub. No.: US 2025/0182557 A1
(43) Pub. Date: Jun. 5, 2025

(54) SYSTEMS AND METHODS FOR TIMED INFLATION GAMES

(71) Applicant: DK Crown Holdings Inc., Boston, MA (US)

(72) Inventors: Jason March, Las Vegas, NV (US); Kyle Morris, Las Vegas, NV (US); Ashford Kneitel, Los Angeles, CA (US); Brent Corey Weiss, Las Vegas, NV (US)

(73) Assignee: DK Crown Holdings Inc., Boston, MA (US)

(21) Appl. No.: 18/527,860

(22) Filed: Dec. 4, 2023

(51) Int. Cl. G07F 17/32

(52) U.S. Cl. CPC G07F 17/3213; G07F 17/3267; G07F 17/3269

(57) ABSTRACT

Described herein are gaming systems and methods for providing timed inflation games. A data processing system can receive a wager and generate a graphical user interface that includes a graphical indicator representing the score for the gameplay along with a first interactive element that updates the score in response to user interaction with it. The state of the graphical indicator increases as the score for the gameplay increases. The data processing system can determine that interaction with the first interactive element has ceased and initiate a timer to count the passage of time up to an expiration threshold. The data processing system can also present a second interactive element that can terminate the gameplay, and the credit balance can be adjusted based on the wager and score in response to user interaction with the second interactive element before the timer expires.

### BACKGROUND

Gaming machines or devices, such as networked gaming devices, can provide awards as a result of gaming events. Players generally place wagers to activate a game and can receive an award when a winning condition is met. However, it can be challenging to provide engaging interactive gaming content.

### SUMMARY

At least one aspect of the present disclosure is directed to a gaming system. The gaming system can include one or more processors coupled to memory. The one or more processors may receive a wager for a play of a game. Upon receiving the wager, the one or more processors cause presentation of a graphical user interface, including a graphical indicator representing a score for the play of the game and a first interactive element that, when interacted with, may cause the score for the play of the game to be updated. In response to a first interaction with the first interactive element, the one or more processors may update a state of the graphical indicator to increase the score for the play of the game. In response to determining that the first interaction with the first interactive element has ceased, the one or more processors may initiate a timer to count the passage of time to an expiration threshold and cause the graphical user interface to present a second interactive element that, when interacted with, may cause the play of the game to terminate. In response to a second interaction with the second interactive element prior to the expiration of the timer, the one or more processors may adjust a credit balance based on the wager and the score of the play of the game.

In some implementations, the one or more processors may cause the graphical user interface to reset the timer responsive to a third interaction with the first interactive element.

In some implementations, the one or more processors may cause the graphical user interface to present a plurality of graphical indicators, with each graphical indicator of the plurality of graphical indicators corresponding to a respective wager. Each graphical indicator of the plurality of graphical indicators can be associated with a respective indicator score.

In some implementations, the one or more processors may generate a respective random score threshold for each graphical indicator of the plurality of graphical indicators. The one or more processors may identify a first subset of the plurality of graphical indicators having the respective indicator score greater than the respective random score threshold. The one or more processors may update the graphical user interface based on the respective indicator score of each graphical indicator of the first subset of the plurality of graphical indicators.

In some implementations, the one or more processors may select a second subset of the plurality of graphical indicators having the respective indicator score less than the respective random score threshold. The second subset may include the graphical indicator. The one or more processors may adjust the credit balance based on the respective wager and the respective indicator score of each graphical indicator of the second subset of the plurality of graphical indicators in response to the termination of the play of the game.

In some implementations, the one or more processors may cause the graphical user interface to generate a respective interactive element for each graphical indicator of the plurality of graphical indicators in response to determining that the first interaction with the first interactive element has ceased. The respective interactive element, when interacted with, may cause the one or more processors to adjust the credit balance based on the respective indicator score of the graphical indicator of the plurality of graphical indicators to which the respective interactive element corresponds.

In some implementations, the one or more processors may increase a size of the graphical indicator based on the score of the play of the game.

In some implementations, the one or more processors may determine that a bonus condition has been satisfied in response to the score for the play of the game exceeding a threshold and adjust the credit balance in response to determining that the bonus condition has been satisfied.

In some implementations, the one or more processors may receive a second wager for a second play of the game. Upon receiving the second wager, the one or more processors may cause presentation of a second graphical user interface for the second play of the game. The second graphical user interface may include a second graphical indicator, with the second graphical indicator corresponding to a second indicator score. The one or more processors update the second indicator score in response to the first interaction with the first interactive element. Upon determining that the second indicator score exceeds a random score threshold, the one or more processors generate a notification for display, with the notification indicating the second wager for the second play of the game has been lost.

In some implementations, the one or more processors may adjust the expiration threshold of the timer based on a user selection.

At least one aspect of the present disclosure is directed to a method of gaming system. The method can include receiving a wager for a play of a game. Upon receiving the wager, the method can include causing presentation of a graphical user interface, including a graphical indicator representing a score for the play of the game and a first interactive element that, when interacted with, may cause the score for the play of the game to be updated. In response to a first interaction with the first interactive element, the method can include updating a state of the graphical indicator to increase the score for the play of the game. In response to determining that the first interaction with the first interactive element has ceased, the method can include initiating a timer to count the passage of time to an expiration threshold and causing the graphical user interface to present a second interactive element that, when interacted with, may cause the play of the game to terminate. In response to a second interaction with the second interactive element prior to the expiration of the timer, the method can include adjusting a credit balance based on the wager and the score of the play of the game.

The method can include causing the graphical user interface to reset the timer responsive to a third interaction with the first interactive element.

The method can include causing the graphical user interface to present a plurality of graphical indicators, with each graphical indicator of the plurality of graphical indicators corresponding to a respective wager. Each graphical indicator of the plurality of graphical indicators can be associated with a respective indicator score.

The method can include generating a respective random score threshold for each graphical indicator of the plurality of graphical indicators. The method can include identifying a first subset of the plurality of graphical indicators having the respective indicator score greater than the respective random score threshold. The method can include updating the graphical user interface based on the respective indicator score of each graphical indicator of the first subset of the plurality of graphical indicators.

The method can include selecting a second subset of the plurality of graphical indicators having the respective indicator score less than the respective random score threshold. The second subset may include the graphical indicator. The method can include adjusting the credit balance based on the respective wager and the respective indicator score of each graphical indicator of the second subset of the plurality of graphical indicators in response to the termination of the play of the game.

The method can include causing the graphical user interface to generate a respective interactive element for each graphical indicator of the plurality of graphical indicators in response to determining that the first interaction with the first interactive element has ceased. The method can include the respective interactive element being interacted with, which causes the one or more processors to adjust the credit balance based on the respective indicator score of the graphical indicator of the plurality of graphical indicators to which the respective interactive element corresponds.

The method can include increasing a size of the graphical indicator based on the score of the play of the game.

The method can include determining that a bonus condition has been satisfied in response to the score for the play of the game exceeding a threshold and adjusting the credit balance in response to determining that the bonus condition has been satisfied.

The method can include receiving a second wager for a second play of the game. Upon receiving the second wager, the method can include causing presentation of a second graphical user interface for the second play of the game. The second graphical user interface may include a second graphical indicator, with the second graphical indicator corresponding to a second indicator score. The method can include updating the second indicator score in response to the first interaction with the first interactive element. Upon determining that the second indicator score exceeds a random score threshold, the method can include generating a notification for display, with the notification indicating the second wager for the second play of the game has been lost.

The method can include adjusting the expiration threshold of the timer based on a user selection.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. For example, by appropriate computer programs, which may be carried on appropriate carrier media (e.g., computer readable media), which may be tangible carrier media (e.g., disks) or intangible carrier media (e.g., communications signals). Aspects may also be implemented using suitable apparatuses, which may take the form of programmable computers running computer programs arranged to implement the aspect. As used in the specification and in the claims, the singular form of “a”, “an”, and “the” include plural referents unless the context clearly dictates otherwise.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A illustrates a block diagram of an example system for providing gaming system functionalities in a client-server configuration, in accordance with one or more implementations;

FIG. 1B illustrates a block diagram of an example system depicting a data processing system that provides gaming functionality using locally-executed game instructions, in accordance with one or more implementations;

FIG. 2A illustrates a graphical user interface for initiating a play of a timed inflation game, in accordance with one or more implementations;

FIG. 2B illustrates an updated graphical user interface generated in response to a request to initiate the play of the timed inflation game, in accordance with one or more implementations;

FIG. 2C illustrates an updated graphical user interface with the initiation of a timer in response to the cessation of inflation of a graphical indicator, in accordance with one or more implementations;

FIG. 2D illustrates a graphical user interface depicting a termination condition, in accordance with one or more implementations;

FIG. 2E illustrates a graphical user interface depicting a winning condition, in accordance with one or more implementations;

FIG. 2F illustrates a graphical user interface depicting multiple graphical indicators, in accordance with one or more implementations;

FIG. 3 illustrates an example flow diagram of a method for providing gaming system functionalities within a timed inflation game, in accordance with one or more implementations; and

FIG. 4 illustrates a block diagram of a server system and a client computer system in accordance with an illustrative implementation.

### DETAILED DESCRIPTION

Below are detailed descriptions of various concepts related to, and implementations of, techniques, approaches, methods, apparatuses, and systems for providing interactive game experiences. The various concepts introduced above and discussed in greater detail below may be implemented in any of numerous ways, as the described concepts are not limited to any particular manner of implementation. Examples of specific implementations and applications are provided primarily for illustrative purposes.

The systems and methods described herein provide engagement features for interactive gaming content, such as the implementation of an inflating balloon game with a cash-out feature, a multiplier, and a time limit. The cash-out feature adds a dimension absent in conventional inflation games, which often do not incorporate any such cash-out options. The cash-out feature allows players to lower their risk of losing their wager by cashing out at any time before the balloon pops. In addition, the more the balloon inflates, the higher the multiplier applied to the wager. Conventional interactive gaming content often lacks the option for players to engage in a more dynamic and engaging game experience, which allows players to lower their risk of losing their wager by cashing out at any time before the balloon pops while still giving them an opportunity to win a large amount of money if the balloon inflates high enough. The time limit adds another level of excitement by forcing players to make a decision to cash out or start inflating the balloon before the timer runs out. Cashing out refers to the process by which the data processing system adjusts a credit balance of the player based on the multiplier and initial wager. Furthermore, cloud computing allows for the distributed provision and processing of interactive gaming features across many player devices, thereby providing improved performance when compared to other implementations. Thus, the systems and methods of this technical solution provide a technical improvement to player device engagement devices by providing additional engagement features not utilized in conventional gaming systems.

The techniques described herein include features and functionalities to enhance the player experience in interactive games. These features may include but are not limited to gameplay mechanics, visual and audio elements, intuitive user interfaces, dynamic game environments, and reward systems. The techniques can be applied to various game genres such as action, adventure, strategy, cards, puzzles, random number or random selection, navigation, counter-based slot machines, simulation, timed inflations, and more. Moreover, the techniques discussed herein allow for the integration of multiplayer capabilities to allow players to engage in collaborative or competitive gameplay experiences with others across various platforms.

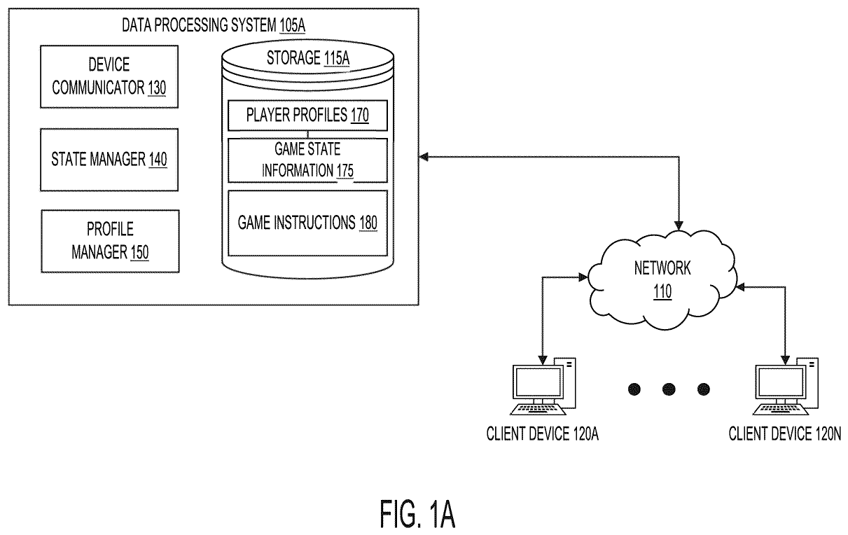

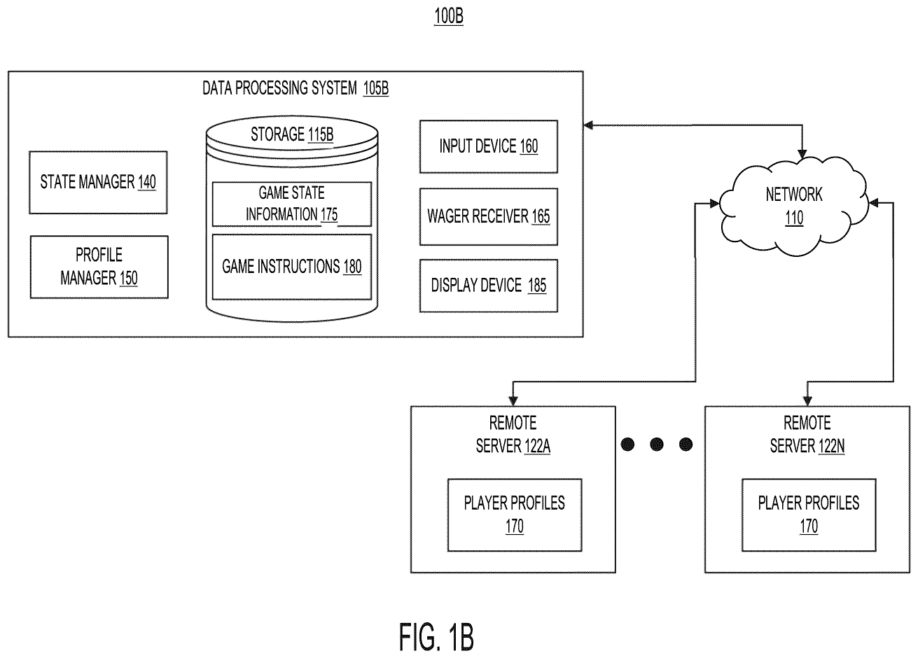

Referring to FIG. 1A, depicted is a block diagram of an example system 100A for providing gaming system functionalities, in accordance with one or more implementations. In FIG. 1A, the system 100A can include at least one data processing system 105A, at least one network 110, and one or more client devices 120A-120N (sometimes generally referred to as client device(s) 120).

In FIG. 1A, the data processing system 105A can include at least one device communicator 130, at least one state manager 140, at least one profile manager 150, and at least one storage 115A. The storage 115A can include one or more player profiles 170, game state information 175, and one or more game instructions 180.

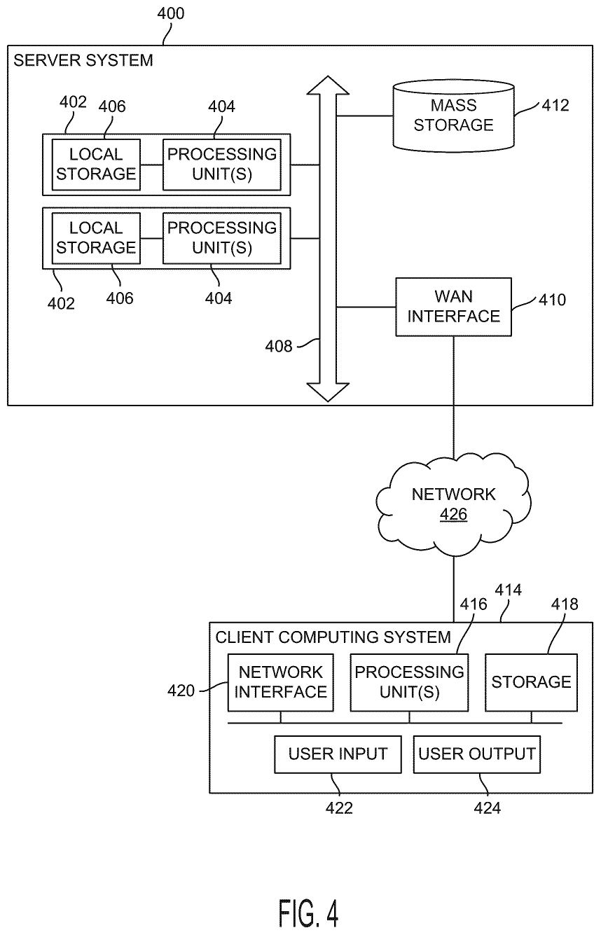

Each of the components (e.g., the data processing system 105A, the network 110, the client devices 120, etc.) of the system 100A can be implemented using the hardware components or a combination of software with the hardware components of a computing system, such as the server 400 or the client computing system 414 described in connection with FIG. 4, or any other computing system described herein.

The data processing system 105A can include at least one processor and a memory, e.g., a processing circuit. The memory can store processor-executable instructions that, when executed by processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105A can include one or more computing devices or servers that can perform various functions as described herein. The data processing system 105A can include any or all of the components and perform any or all of the functions of a server system 400 described herein in conjunction with FIG. 4.

The network 110 can include computer networks such as the Internet, local, wide, metro or other area networks, intranets, satellite networks, other computer networks such as voice or data mobile phone communication networks, and combinations thereof. The data processing system 105A of the system 100A can communicate via the network 110, for example with one or more client devices 120. The network 110 may be any form of computer network that can relay information between the data processing system 105A, the one or more client devices 120, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks.

The network 110 may also include any number of computing devices (e.g., computers, servers, routers, network switches, etc.) that are configured to receive and/or transmit data within the network 110. The network 110 may further include any number of hardwired and/or wireless connections. Any or all of the computing devices described herein (e.g., the data processing system 105A, the one or more client devices 120, the server system 400, the client computing system 414, etc.) may communicate wirelessly (e.g., via Wi-Fi, cellular, radio, etc.) with a transceiver that is hardwired (e.g., via a fiber optic cable, a CAT5 cable, etc.) to other computing devices in the network 110. Any or all of the computing devices described herein (e.g., the data processing system 105A, the one or more client devices 120, the server system 400, the client computing system 414, etc.) may also communicate wirelessly with the computing devices of the network 110 via a proxy device (e.g., a router, network switch, or gateway).

Each of the client devices 120 can include at least one processor and a memory, e.g., a processing circuit. The memory can store processor-executable instructions that, when executed by processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 120 can include one or more computing devices or servers that can perform various functions as described herein. The one or more client devices 120 can include any or all of the components and perform any or all of the functions of the client computing system 414 described herein in conjunction with FIG. 4.

Each client device 120 can include, but is not limited to, a mobile device (e.g., a smartphone, tablet, etc.), a television device (e.g., smart television, set-top box, et.), a personal computing device (e.g., a desktop, a laptop, etc.) or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, a display, etc.) and one or more input/output (I/O) devices (e.g., a mouse, a keyboard, digital keypad). The display can include one or more portions, for example, to display multiple in-game events as described herein. The display can include a touch screen displaying an application, such as the gaming applications described herein. The display can include a border region (e.g., side border, top border, bottom border).

In some implementations, the display can include a touch screen display, which can receive interactions from a player. The interactions can result in interaction data, which can be stored and transmitted by the processing circuitry of the client device 120. The interaction data can include, for example, interaction coordinates, an interaction type (e.g., click, swipe, scroll, tap, etc.), and an indication of an actionable object with which the interaction occurred. Each client device 120 can include an input device that enables a player to interact with and/or select one or more actionable objects as described herein. For example, a touchscreen display can enable interaction with one or more visual indications provided through the display of each mobile (or client) device 120, and responsive to an interaction (e.g., select, click-on, touch, hover), the client device 120 can generate an indication identifying a player input and/or selection of a wager, an in-game event, or an indication to participate in a bonus event, among others.

Each client device 120 can include a device identifier, which can be specific to each respective client device 120. The device identifier can include a script, code, label, or marker that identifies a particular client device 120. In some implementations, the device identifier can include a string or plurality of numbers, letters, characters or any combination numbers, letters, and characters. In some implementations, each client device 120 can have a unique device identifier. Each client device 120 can include a client application, which can be a gaming application that communicates with the data processing system 105A to play games, as described herein. The client application can include an application executing on each client device 120 or provided to the client device 120 by the gaming system.

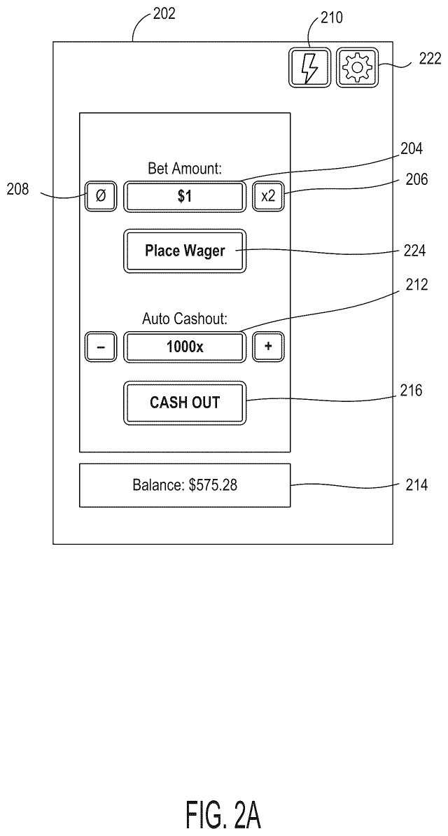

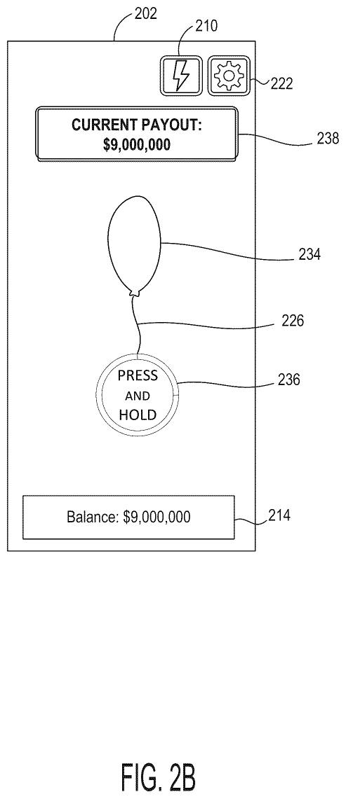

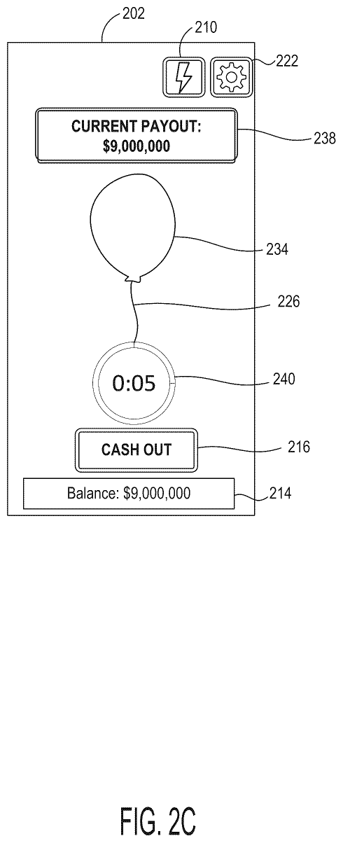

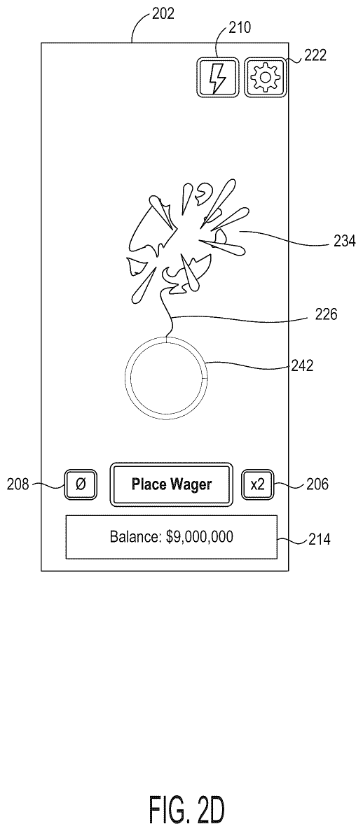

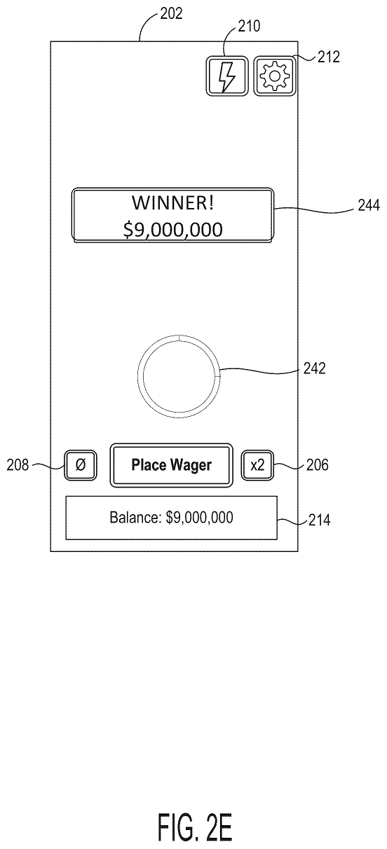

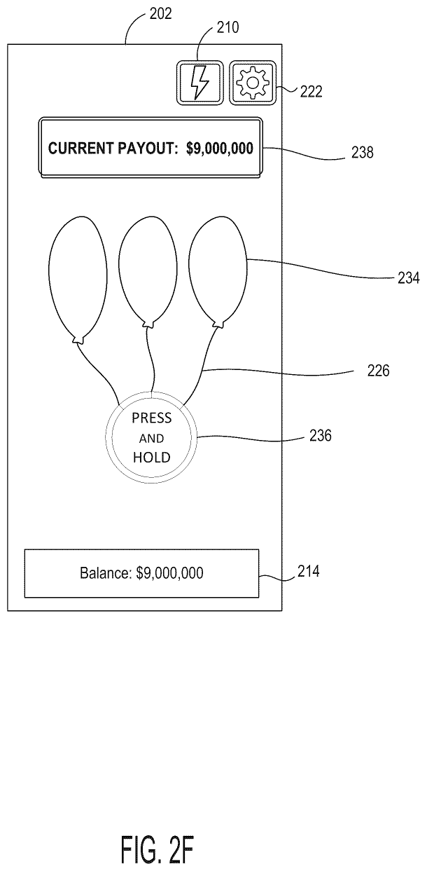

The application can include a web application, a server application, a resource, a desktop, or a file. In some implementations, the application can include a local application (e.g., local to a client device 120), hosted application, Software as a Service (SaaS) application, virtual application, mobile application, and other forms of content. In some implementations, the application can include or correspond to applications provided by remote servers or third-party servers. In some implementations, the application can access the player profiles 170, the game state information 175, or the game instructions 180, stored and maintained at the storage 115A, and generate one or more actionable objects, such as the actionable objects described herein below in connection with FIGS. 2A-2F, to a player through a client device 120. Such actionable objects can include player-selectable hyperlinks, buttons, graphics, videos, images, or other application features that generate a signal that is processed by the application executing on the respective client device 120.

In some implementations, one or more client devices 120 can establish one or more communication sessions with the data processing system 105A. The one or more communication sessions can each include a channel or connection between the data processing system 105A and the one or more client devices 120. The one or more communication systems can each include an application session (e.g., virtual application), an execution session, a desktop session, a hosted desktop session, a terminal services session, a browser session, a remote desktop session, a URL session and/or a remote application session. Each communication session can include encrypted and/or secure sessions, which can include an encrypted file, encrypted data or traffic. The client devices 120 can each use the communication session established with the data processing system 105A to carry out any of the functionalities described herein. For example, the application executing on a client device 120 can perform any of the client-side operations described herein, including displaying any of the user interfaces shown in FIGS. 2A-2F, or any other types of user interfaces described herein.

Each of the client devices 120 can be computing devices configured to communicate via the network 110 to access information resources, such as web pages via a web browser, or application resources via a native application executing on a client device 120. When accessing information resources, the client device can execute instructions (e.g., embedded in the native applications, in the information resources, etc.) that cause the client devices to display gaming application interfaces, such as the user interface described herein below in conjunction with FIGS. 2A-2F. The gaming application interfaces can be, for example, application interfaces that present different types of casino games, or other types of interactive video games. In general, video games include content (e.g., images, video, animations, graphics, audio, etc.) that is presented to a player via the input/output interfaces of a client device 120.

In response to interactions with user interface elements, the client devices 120 can transmit information, such as player profile information (e.g., changing player profile parameters, changing login information, any information stored in a player profile 170, etc.), interaction information, selections of wager amounts, selections of gaming participation events, or other signals to the data processing system 105A. In some implementations, a client device 120 can transmit a request to initiate a gaming session, and requests for additional gameplay features during a gaming session. The request can include, for example, a request to play a particular game (e.g., can include a game identifier, etc.). The request can be a hypertext transfer protocol (HTTP or HTTPS) request message, a file transfer protocol message, an email message, a text message, or any other type of message that can be transmitted via the network 110.

The data processing system 105A is shown as including the storage 115A. The storage 115A can be a computer-readable memory that can store or maintain any of the information described herein. The storage 115A can maintain one or more data structures, which may contain, index, or otherwise store each of the values, pluralities, sets, variables, vectors, numbers, or thresholds described herein. The storage 115A can be accessed using one or more memory addresses, index values, or identifiers of any item, structure, or region maintained in the storage 115A. The storage 115A can be accessed by the components of the data processing system 105A, or any other computing device described herein, via the network 110. In some implementations, the storage 115A can be internal to the data processing system 105A. In some implementations, the storage 115A can exist external to the data processing system 105A and may be accessed via the network 110. For example, the storage 115A may be distributed across many different computer systems (e.g., a cloud computing system) or storage elements and may be accessed via the network 110 or a suitable computer bus interface.

The data processing system 105A can store, in one or more regions of the memory of the data processing system 105A, or in the storage 115A, the results of any or all computations, determinations, selections, identifications, generations, constructions, or calculations in one or more data structures indexed or identified with appropriate values. Any or all values stored in the storage 115A may be accessed by any computing device described herein, such as the data processing system 105A, to perform any of the functionalities or functions described herein. In implementations where the storage 115A forms a part of a cloud computing system, the storage 115A can be a distributed storage medium in a cloud computing system and can be accessed by any of the components of the data processing system 105A, by the one or more client devices 120 (e.g., via the user interface similar to that depicted in FIGS. 2A-2F, etc.), or any other computing devices described herein.

The storage 115A can store one or more player profiles 170 associated with a user (referred to herein as a “player”) of a client device 120. A player profile 170 of a player can be a user profile that includes information about the player and information about one or more of the client devices 120 used to access the data processing system 105A using the player profile 170. For example, identifiers of the player profile 170 can be used to access the functionality of the data processing system 105A (e.g., by logging into the data processing system 105A via one or more web-based interfaces). The identifiers can include a username, a password, an e-mail address, a phone number, a personal identification number (PIN), a secret code-word, device identifiers for use in a two-factor authentication technique, among others. The player profile 170 can store information about wagers, games, and gaming events that are performed by the player via the data processing system 105A. The player profile 170 can store a credit balance, wager information or side wager information (e.g., an amount of a wager/side wager, a timestamp associated with a wager/side wager, information about gaming conditions or game state information that resulted in a side wager, a client device identifier of a client device that was used to place the wager/side wager, etc.). The player profile 170 can store information about a client device used to access the data processing system 105A such as an IP address, a MAC address, a GUID, a player profile name (e.g., the name of a user of the client device 120, etc.), device name, among others. In some implementations, the player profile 170 can be created by the data processing system 105A in response to the player profile creation request transmitted by a client device 120. The player profile creation request can include any of the player profile information described herein.

The storage 115A can store or maintain game state information 175 associated with each of the one or more player profiles 170, for example, in one or more data structures. The game state information 175 can include information for games previously or currently played or otherwise accessed by a client device 120 using a corresponding player profile 170. In some implementations, a client device 120 accessing the data processing system 105A may not be associated with a player profile 170. In such implementations, the data processing system 105A can automatically create a player profile 170 using an identifier of the client device 120 provided by the client device 120. The game state information 175 can include information about previous wagers, side wagers, hands, actions, interactions, or other data provided by the client device 120 during the play of a game provided by the data processing system 105A. As described in further detail herein, the state manager 140 can maintain (e.g., store, update, etc.), in corresponding game state information 175, a respective game state of games as they are being played for multiple players accessing the data processing system 105A. The game state information 175 can include one or more data structures that include any information related to a game state, such as current cards held by a player (e.g., in a blackjack game, poker game, or another card game, etc.), wager information, information about whether the player has indicated a desire to participate in additional bonus award opportunities, or other game state data described herein.

The game state information 175 can include turn information (e.g., which user has the current turn, how many game turns have elapsed, etc.) for one or more games provided via the data processing system 105A. In some implementations, information used to update the game state information 175 can be received as a play of the game occurs (e.g., as the play is processed by the data processing system 105A according to the game instructions, etc.). The game state information 175 can include options that a player may take at each portion of a game, and any actions (e.g., interactions, pausing/waiting for a particular duration at stored timestamps, etc.) the client device 120 takes in response to said options. In some implementations, if multiple hands are being controlled by a player via the client device 120 for a single play of a card game (e.g., multiple hands for a single round of blackjack, poker, or another card game, etc.), the game state information 175 can include game state information for each of the hands under control of the player. In addition, the game state information 175 can include information relating to the conditions of additional wagers.

In some implementations, the game state information 175 can include details about a timed inflation game. This can include the number of balloons selected for the play of the game, the number of plays of the game in which the player has participated, any timers that are initiated during the plays of the game, and any interactions that are received before the expiration of different timers. The interactions can include interactions with various interactive user interface elements, which can cause the data processing system 105A to adjust a credit balance of the player (e.g., cashing out) or initiate a subsequent play of the game. The game state information 175 can also include the score generated based on each inflation. The score increases with the inflation of the balloon until the balloon pops, is manually cashed out, or is automatically cashed out (e.g., when the timer expires). The game state information 175 can also include the wagers that have been placed by players, the payout odds for each wager, the outcome history of previous gameplays, and whether the current play (sometimes referred to as a “round” or a “play” of the game) satisfies any predetermined game conditions based on the outcome.

The storage 115 can store or maintain game instructions 180. The game instructions 180 can include instructions to play various games (e.g., inflating games, including the timed inflation games). The game instructions 180 can specify one or more game events that occur in response to a particular game state. The game instructions can include instructions to play a game from start to finish, for example, by streaming gaming content to each of the client devices 120 that initiate play of a particular game, or by executing the game instructions and displaying content via a local display device. The game instructions 180 can be stored in one or more data structures that are indexed by a game name (e.g., blackjack, poker, rummy, craps, sic bo, Klondike, any other game, etc.). The game instructions 180 can be processor executable instructions that cause the data processing system 105A to provide one or more games to a client device 120 via a communication session.

In some implementations, the game instructions 180 can include artificial intelligence models (e.g., machine learning models, neural network, decision trees, ruled-based lookup table, etc.) that cause the data processing system 105A to play an opposing entity to a player of one of the games in the game instructions 180. For example, the artificial intelligence model can provide a simulated dealer in a blackjack game, a simulated player in a poker game, or other simulated players, dealers, or game entities. In some implementations, the game instructions 180 can include game instructions that allow a play of a game to progress with multiple hands. For example, in a multi-hand card game, the game instructions 180 can include instructions that accommodate multiple hands being controlled by a single player.

The game instructions 180 can include, or may include instructions for generating, odds information, which can be stored as probability values of certain in-game events occurring. The odds information may further define one or more probability distributions that may be sampled to determine an outcome of one or more events in the game according to the game instructions 180. In some implementations, the odds information may be altered based on actions taken by the player, or the odds information can correspond to the likelihood of one or more outcomes (e.g., an expected value of player loss, an expected value of player win, etc.). For example, in the timed inflation games described herein, the odds define the probability of a balloon inflating to different levels. A pay table for the timed inflation games can specify awards, if any, associated with different inflation levels, and the odds information provides the underlying probabilities for those inflation levels in some implementations.

The game instructions 180 can also cause the game state information 175 for a game to be updated as the game is played via a client device 120. For example, in some implementations, the game instructions can update the odds information in response to an indication (e.g., as stored in the game state information 175, etc.) to participate in an additional bonus opportunity, such as a bonus play of the game, a separate bonus game, or a side wager or insurance bet that may result in an additional or alternative award.

In some implementations, where the game instructions 180 provide instructions for a game that implements a side wager, the game instructions 180 can specify the conditions under which the player is able to place the side wager and the conditions under which the player is to be awarded with awards according to a side wager when a corresponding side wager condition is met (e.g., at game termination, on player win, on player loss, etc.). Each of the components of the data processing system 105A can access, update, or modify the player profiles 170, the game state information 175, or the game instructions 180, to carry out functionalities.

In some implementations, the game instructions 180 can provide instructions for a timed inflation game. In a brief overview of example game instructions 180, upon receiving a wager, the data processing system 105A can present a graphical user interface with a graphical indicator (e.g., a balloon) that is to be inflated during the play of the game. The game instructions 180 can specify the scores determined based on the start time of the play and the multiplier values associated with different inflation levels. When a player stops inflating the balloon, a timer is initiated, during which the player can either manually cash out or initiate inflating the balloon again before the timer expires. If the timer expires, the credit balance is automatically adjusted. Cashing out, which is the process of adjusting the credit balance of the player, generates a score based on the start time of the play and the multiplier value associated with the inflation level at the time of cashing out. The credit balance is then updated accordingly. The game instructions 180 can also include several game conditions, such as termination condition(s) or bonus condition(s) based on the score.

Referring now to the operations of the data processing system 105A, the device communicator 130 can establish a game session with a client device in response to a request from a client device. Establishing the game session may include generating game state information 175 for the player profile 170 used to access the data processing system 105A to initiate the play of the game. The request to establish a game session may include a request to play a game, which may be received in one or more messages from an application executing on the client device 120. The message, or request, can indicate that a player intends to play a game provided by the data processing system 105A. The message can include an indication of a player profile 170 with which to use for the functionalities related to the game (e.g., placing wagers using earned credits, purchasing additional credits, etc.).

The message can include an identifier of a particular game to play. In some implementations, the device communicator 130 can provide the client device 120 with instructions to display one or more games to play in a list, allowing the player to select a game from the list. In response to an interaction indicating a selection, the client device 120 can transmit a signal identifying a game to the data processing system 105A. Using the game selection, the data processing system 105A can communicate a user interface for the game generated according to the game instructions 180 for the game and the game state information 175 for the game session. Such graphical user interfaces are shown in FIGS. 2A-2F.

In some implementations, the game can a card-based game, which can include (but is not limited to) poker, blackjack, rummy, or other similar games. Furthermore, in some implementations, the game can be a dice-based game, which can include (but is not limited to) a game of craps, sic bo, or Klondike.

A play of a game can be a single “round” or play-through of a game to a termination condition (e.g., a condition after which the player has won or lost the wagers for a single instance of the game, etc.). To initiate a play of the game, or during a play of the game, the device communicator 130 can receive one or more wagers from the client device 120 (e.g., in response to corresponding user interface elements presented at the client device 120, as described herein). The wager(s) may specify a wager amount. The wager amount provided by the client device 120 can be a specified amount of credits, such as 1, 5, 25, 100, 500, or 1000 credits. In some implementations, the player can specify a custom number or fractional number of credits used in the game, each of which may correspond to a respective condition, outcome, or aspect of the game. In some implementations, the wagers may include side wagers, additional wagers, or other wagers placed prior to or during a play of the game.

The client device 120 (or an application executing on the client device 120) can receive data relating to the requested game from the device communicator 130. The data relating to the requested game can include or may be generated based on game state information 175, which can be maintained by the state manager 140, as described herein. The device communicator 130 may determine updated information to provide to the client device 120 based on the game state information 175 for the game, which is initialized and updated by the state manager 140.

The state manager 140 can update and maintain the game state information 175. The game state information 175 may refer to the current state of a game, which includes various information such as the number of balloons selected for the play of the game, the number of plays of the game in which the player has participated/initiated, any timers that are initiated during the plays of the game described herein, and any interactions that are received before the expiration of different timers or game events, among others. The interactions can include interactions with various interactive user interface elements, which can cause the data processing system 105A to adjust a credit balance of the player or initiate a subsequent play of the game, as described herein. The state manager 140 can also update the game state information 175 based on the scores generated on each inflation until a score threshold is reached (e.g., the balloon pops), is manually cashed out, or is automatically cashed out (e.g., when the timer expires). The state manager 140 also updates the game state information 175 based on manual and automatic cashing out from a play or any other game events that may affect the game state information 175. Additionally, if the game involves randomness, such as the random popping of a balloon, the state manager 140 updates the game state information 175 accordingly.

The profile manager 150 can create, modify, or delete player profiles 170 stored within storage 115A. The profile manager 150 can store and organize player information, including account details, preferences, and gaming history, among others. The profile manager 150 can generate profile information based on data received from the client devices 120. This allows the profile manager 150 to capture activity across different gaming applications and different devices, and store records of that activity in the player profile 170. The profile manager 150 can provide gaming statistics (e.g., historical game outcomes), and game progress to a requesting client device 120.

The profile manager 150 can update credit balances, game statistics, and other relevant information based on the outcomes of games played by a client device 120. The profile manager 150 can receive data about game results from the client devices 120 or the state manager 140 and use this information to make adjustments to the player profile 170. For example, if a player wins a timed inflation game with a $10 wager, the profile manager 150 would increase their credit balance by the corresponding amount (the amount of the wager plus the amount awarded). Similarly, the profile manager 150 can store game statistics such as the number of wins, losses, and ties, as well as the player's average bet size, win percentage, and longest winning streak. This allows players to track their progress and review their gaming history. For example, a player could see that they have a 60% win rate in their timed inflation games and an average bet size of $10. This information could help the player make better decisions about how to bet in the future.

Referring now to FIG. 1B, depicted is a block diagram of an example system 100B comprising at least one data processing system 105B, a network 110, and one or more remote servers 122A-122N (also generally referred to as a remote computing system 122). Various components of the system 100B shown in FIG. 1B may be similar to, and include any of the structure and functionality of, the system 100A of FIG. 1A. For example, the network 110 shown in FIG. 1B is similar to the network 110 in FIG. 1A, differing only in its role of facilitating the connection between the data processing system 105B and the remote computing system 122. Additionally, the components of the data processing system 105B may include some or all of the structure and functionality of their specific counterparts in FIG. 1A. For example, the data processing system 105B, similar to the implementation shown in FIG. 1A, includes a storage 115B, a state manager 140, and a profile manager 150. The data processing system 105B in FIG. 1B may further include one or more of an input device 160, a wager receiver 165, and a display device 185. The storage 115B may be similar in structure and functionality to the storage 115A and may store the game state information 175 and one or more game instructions 180.

The configuration shown in FIG. 1B may be used to implement a local gaming device, which may provide games locally without necessarily communicating with one or more remote servers 122A-122N. In one implementation, the data processing system 105B of the system 100B may implement a Kiosk device, a portable gaming device, or a stationary gaming system. As shown, the data processing system 105B (or the components thereof) may communicate with one or more remote servers 122A-122N, for example, to access or update player profiles 170 maintained at the one or more remote servers 122A-122N.

As discussed above, the system 100B may include a remote computing system 122 having one or more remote servers 122A-122N. The remote computing system 122 can securely store and provide access to player profiles for games played on the data processing system 105B. In some implementations, the remote computing system 122 may include a file server, application server, web server, proxy server, appliance, network appliance, gateway, gateway server, virtualization server, deployment server, SSL VPN server, or firewall. The remote servers 122A-122N may store, or otherwise maintain, player profiles 170, which may be created, updated, or deleted based on communications with the data processing system 105B.

The data processing system 105B can include an input device 160, which can implement an interface between a player and the data processing system 105B. Players can interact with the input device 160 to provide commands to control the functionality of the data processing system 105B, for example, to play one or more games as described herein. In some implementations, the input device 160 can include but is not limited to one or more physical buttons (such as a slot machine arm), a keyboard, a mouse, a touchscreen, a virtual input interface, tokens, chips, or other suitable input means known in the art. Interactions provided via the input device 160 allow a player to perform graphical user interface functionality, such as navigating menus, making selections to trigger game events, entering commands, or otherwise controlling play of one or more games provided via the data processing system 105B.

The data processing system 105B includes a wager receiver 165, which can receive and process wagers made by players. The wager receiver 165 may include a coin slot where players can insert coins or tokens as part of wagers. In some implementations, the wager receiver 165 may also include a card reader that allows players to use electronic cards or tickets for placing bets. Furthermore, the wager receiver 165 may include a touchscreen, allowing players to make their wagers by directly interacting with the screen. The aforementioned examples for the wager receiver 165 are not exhaustive and may include other suitable components or technologies for receiving and processing wagers, such as near-field communication (NFC) or wireless communication with a mobile device.

The wager receiver 165 allows players to place bets or wagers for the various games provided by the data processing system 105B. Upon receiving a wager, the wager receiver 165 may provide a signal to the components of the data processing system 105B to initiate a game, initiate a play of a game, or advance a game state of the game, among other actions. In some implementations, wager receiver 165 can determine whether a received wager conforms to the game's requirements and rules (e.g., appropriate amount, type of bet, etc.). If any issues are detected, such as an invalid bet amount or an unsupported bet type, the data processing system 105B may prompt the player to revise their wager. Additionally, the data processing system 105B may check if the player has sufficient funds or credits to place the bet. The data processing system 105B reviews the player's account balance or credit balance through the profile manager 150 to make sure that they have the necessary funds available. Furthermore, the data processing system 105B applies any relevant game-specific restrictions to the wager. These restrictions can include minimum or maximum bet limits, specific betting options, or combinations.

The data processing system 105B includes a display device 185, which serves as the visual interface for players. The display device 185, integrated within the data processing system 105B, can take various forms, such as a monitor, screen, or any other suitable visual output mechanism. The display device 185 may include a touchscreen interface. Touchscreens are becoming increasingly popular as they offer a more intuitive way to interact with devices. Touchscreens may include displays that present graphical user interfaces, which may include icons, buttons, and other graphical elements that can be interacted with by touching the screen. For example, as shown in FIGS. 2A-2F, the graphical user interface can display the game graphics, interactive objects, and other relevant information that players need to interact with the data processing system 105B.

In some implementations, the data processing system 105B may transmit game-related information to the remote computing system 122 when the player requests a game or when the game state changes. This data includes game state information 175, which is managed by the state manager 140 within the data processing system 105B. Updated game state information 175 that reflects the changes occurring during the play of a game may be synchronized or otherwise provided to the remote servers 122A-122N.

The data processing system 105B can include a profile manager 150 that can provide messages to update one or more player profiles 170 stored within the remote computing system 122. The profile manager 150 can retrieve and store player-specific data, including preferences, gaming history, achievements, content they engage with, preferred wagering amounts across various games, and other relevant information, from the remote computing system 122.

As discussed above, the system 100B includes a remote computing system 122 that can store player profiles 170. The remote computing system 122 can allow the data processing system 105B, via the profile manager 150, to update player profiles 170 during or based on outcomes of games. For example, when a player interacts with the data processing system 105B, the player can provide an identifier for their player profile 170 via the input device 160 or wager receiver 165. The data processing system 105B can then communicate with the remote computing system 122 to retrieve the relevant player profile information based on the identifier. The identifier of the player profile 170 could be a username, an email address, a phone number, or a social media handle, among others. Similarly, when changes occur in the player's profile, such as the outcomes of games, plays, or adjusting the credit balance of the player profile 170, etc., the profile manager 150 within the data processing system 105B updates the player profile 170. Subsequently, the data processing system 105B communicates these updates to the remote computing system 122.

Referring now to one example implementation of a timed inflation game, the data processing system 105A receives a wager and generates a graphical user interface. The graphical user interface presents a graphical indicator (e.g., a balloon) and a first interactive element, which updates the state of the graphical indicator to increase the score for the play. The data processing system 105A can determine when the interaction with the first element has ceased and initiate a timer to count the passage of time to an expiration threshold. During the timer's runtime, the graphical user interface is updated to present a second interactive element. In response to interaction with the second interactive element, the data processing system 105A can terminate the play of the game and adjust a credit balance based on the wager and the score for the play of the game. The data processing system 105A can update and display updated information (e.g., the number of inflations, the score increased on each inflation, the timer initiations, etc.) on the graphical user interface. Example graphical user interfaces showing an example implementation of a timed inflation game are shown in FIGS. 2A-2F.

Referring now to FIG. 2A in the context of the components described in connection with FIGS. 1A and 1B, a graphical user interface 202 is presented on a client device 120 for initiating a play of the timed inflation game. As discussed above, the device communicator 130 facilitates communication between the client device 120 and the data processing system 105A, allowing players to interact with a graphical user interface 202 and transmit their actions to the data processing system 105A. As players engage with the graphical user interface 202, their actions, such as placing bets or initiating the game, may be captured and stored in their player profile 170.

As shown on the graphical user interface 202, a player can interact with a bet amount button 204 that enables the player to specify the amount of the wager. A multiplier button 206 is present that, when interacted with, can cause the bet amount to be updated to double the value of the player's wager. The graphical user interface 202 can display a clear button 208 that, when interacted with, may cause the wager to be reset (e.g., removed or erased). In some implementations, the graphical user interface 202 can be updated via the clear button 208 to reset the wager amount to a default value. In some implementations, the graphical user interface 202 may display a lightning bolt button 210 (or the graphical user interface 202 may include other indicators in some implementations) that can cause the data processing system 105A to alter the animation speeds in response to an interaction with the lightning bolt button 210. The lightning bolt button 210 can be toggled on or off by the player during the gameplay. The animation speeds may be modified to increase or decrease the amount of time taken to update the game state. In some implementations, the graphical user interface 202 can display a separate slider/interactive element that enables the player to select the rate at which their score increases (e.g., the rate at which the balloon is shown inflating). In some implementations, the lightning bolt button 210 can be a part of the manual bet interface to allow manual control of the speed of the game.

Players can also select a multiplier for auto-cashout by interacting with an auto-cashout button 212. Once the selected multiplier value is reached, the data processing system 105A will automatically cash out the player, as described herein. In some implementations, a player can increase or decrease the multiplier value by interacting with the plus or minus signs indicated on the auto-cashout button 212. In some implementations, a player can manually enter the multiplier value. However, if no value is entered, the data processing system 105A can default the multiplier value to a predetermined maximum value (e.g., 1000×), as shown. A balance region 214 displays the amount of credits available for the player to wager on the game. The amount shown in the balance region 214 may be determined from the credit balance specified in the player profile 170 of the player. The balance region 214 may be updated in response to interactions with the bet amount button 204. A cash out button 216 is present that, when interacted with, causes the data processing system 105A to update the player profile 170 and cash out the player.

Player can interact with a wager button 224 to place a wager for the play of the game. The wager information is then transmitted from the client device 120 to the data processing system 105A. The data processing system 105A receives and processes the wagers, incorporating them into the game logic. The player profile 170 is also updated with the wager information. Players can also initiate the game by interacting with the wager button 224. This interaction causes the data processing system 105A to update the graphical user interface 202 and present a graphical indicator 234 (one or more graphical indicators 234 in some implementations), as shown in connection with FIG. 2B.

Referring now to FIG. 2B, in the context of the components described in connection with FIGS. 1A and 1B, an updated graphical user interface 202 is presented on the client device 120 in response to an interaction with the wager button 224 shown in FIG. 2A. A graphical representation of a balloon 234 is displayed with an interactive press-and-hold button 236 on the graphical user interface 202. The balloon 234 is shown as connected to the interactive press-and-hold button 236 on the graphical user interface 202 via a virtual string 226. In this example, the graphical indicator 234 is shown as a balloon for illustrative purposes. However, in some implementations, the player can select different graphical indicator designs or shapes using a settings button 222, which updates the graphical user interface 202 to a second graphical user interface that presents the selectable graphical indicators 234.

In response to receiving an interaction with the press-and-hold button 236, the data processing system updates the game state information 175 and starts inflating the graphical representation of the balloon 234. The data processing system 105A inflates the graphical representation of the balloon 234 by increasing the size (or state) of the graphical representation of the balloon 234 according to the increase in score. Inflation levels are a measure of how much the graphical representation of the balloon 234 has been inflated. They can be represented by a number ranging from 0 to 1, where 0 (or any predefined endpoint) represents a completely deflated balloon and 1 (or any predefined endpoint) represents a fully inflated balloon. In some implementations, the inflation levels can be calculated based on the player's score. The data processing system 105A continues to inflate the graphical representation of the balloon 234 until the player releases the press-and-hold button 236.

A score for the balloon 234 can be determined based on the wager selected and the multiplier values associated with different inflation levels. In some implementations, the score can be based on the start time of the play and the multiplier value associated with the inflation level at the time of cashing out, as described herein. In some implementations, the data processing system 105A can associate a predetermined multiplier value (e.g., based on the game instructions 180) with the inflation of the balloon 234, and the multiplier value (or the computed score in general) can be used to determine how much the size of the graphical representation of the balloon 234 increases each time the press-and-hold button 236 is interacted with. Different multiplier values can be associated with different inflation levels. For example, a higher multiplier value can be associated with a higher inflation rate. The data processing system 105A can dynamically adjust the multiplier value based on the player's performance or other factors. The graphical user interface 202 and the corresponding game state information 175 are updated every time the data processing system 105A receives an interaction with the press-and-hold button 236. The graphical user interface 202 is updated to display the current payout 238, corresponding to the current inflation level of the balloon 234. The current payout 238 can be calculated based on the current inflation level of the balloon 234 and the predetermined multiplier value associated with the inflation level. When the data processing system 105A identifies that the player has stopped interacting with the press-and-hold button 236, the graphical user interface 202 is dynamically updated to transform the press-and-hold button 236 into a timer 240, as shown in connection with FIG. 2C.

Referring now to FIG. 2C, in the context of the components described in connection with FIGS. 1A and 1B, an updated graphical user interface 202 is presented on the client device 120 in response to the cessation of inflation of the balloon 234. Upon identifying that the player has ceased interacting with the press-and-hold button 236, the data processing system 105A initiates a transformation of the press-and-hold button 236 into a timer 240. The timer 240 begins to decrement from a predetermined expiration threshold (based on the game instructions 180 or user preferences), effectively starting a countdown. The graphical user interface 202 is also updated to present the cash out button 216, with which the player can interact to manually cash out the current payout 238, or the data processing system 105 will automatically cash out the player if no interaction is received from the player (e.g., when the timer 240 expires). The player profile 170 is updated accordingly. In some implementations, the data processing system 105A can update the graphical user interface 202 and initiate inflating the balloon 234 again (or updating the state of the balloon 234) if the data processing system 105A receives an interaction with the timer 240 before its expiration. Upon detecting such interaction, the graphical user interface 202 is updated to transform the timer 240 into the press-and-hold button 236. The graphical user interface 202 can then be updated to remove the cash-out button 216 in response to the interaction with the timer 240.

The data processing system 105A can increment the score as described herein as the player interacts with the press-and-hold button 236, which may be graphical represented by showing the balloon 234 inflate on the graphical user interface 202. The score can continue to increment until a player manually cashes out, the data processing system 105A automatically initiates a cash-out based on predetermined criteria, the timer 240 expires, or the data processing system 105A generates a random score threshold in accordance with the game instructions 180 and causes the balloon 234 to pop upon its score exceeding the random score threshold, as shown in connection with FIG. 2D.

Referring now to FIG. 2D, in the context of the components described in connection with FIGS. 1A and 1B, an updated graphical user interface 202 is presented on the client device 120 depicting a termination condition. The termination condition may cause the data processing system 105A to terminate the play of the game, without providing the player with an award (e.g., the player loses the game). Upon the data processing system 105A detecting that the player has lost the game, the data processing system 105A can update the graphical user interface 202 to graphically represent the player losing the game. In this example, the data processing system 105A has updated the graphical user interface 202 to show the balloon 234 popping. In implementations where the player has won the game (e.g., the cash out button 216 was interacted with, the timer 240 expired, etc.), the data processing system 105A can update the player profile 170 with an indication that the player won the game.

In some implementations, the data processing system 105A can generate a random score threshold, which may be used to determine whether the player has lost the play of the game. In some implementations, the random score threshold can be predetermined prior to presenting the balloon 234 on the graphical user interface 202. If, during the play of the game, the score is equal to or greater than the random score threshold, the data processing system 105A can determine that the player has lost the play of the game and update the graphical user interface 202 accordingly. In some implementations, the data processing system 105A can determine the random score threshold based on a variety of factors, such as the game mode, the player's level, or the current score, among others. Once the balloon 234 pops, the data processing system 105A updates the game state information 175. The graphical user interface 202 is also updated to display a pre-rendered animation of the balloon 234 popping, which causes the data processing system 105A to update the credit balance of the player profile 170. The graphical user interface 202 is updated to transform the press-and-hold button 236 into a non-interactive button 242, which restricts the ability of the player to further interact with the press-and-hold button 236. The data processing system 105A updates the credit balance of the player profile 1701 accordingly.

Referring now to FIG. 2E, in the context of the components described in connection with FIGS. 1A and 1B, an updated graphical user interface 202 is presented on the client device 120 depicting a win condition. In some implementations, the termination condition (or the game condition in general) may correspond to a win condition that is satisfied when the score of the balloon 234, determined based on the initial wager and multiplier value associated with the inflation levels of the balloon 234, reaches a predetermined score threshold, as shown in connection with FIG. 2F. The predetermined score threshold can be based on a variety of factors, such as the difficulty level of the game or the multiplier value associated with the balloon 234, among others. When the win condition is satisfied (e.g., the player has won the game by interacting with the cash out button 216 or by waiting for the time 240 to expire), the data processing system 105A can update graphical user interface 202 to transform the press-and-hold button 236 to a non-interactive button 242 and remove the balloon 234. The data processing system 105A can also update the graphical user interface 202 to provide a notification 244 (or feedback in general) to the players, indicating that the win condition has been satisfied. The notification 244, which also includes the award amount, is displayed in the center of the graphical user interface 202. The general feedback can include various sensory elements, such as visual, auditory, or tactile (e.g., haptic) feedback. The data processing system 105A can update the credit balance of the player profile 170 in response to the satisfaction of the win condition.

Referring now to FIG. 2F, in the context of the components described in connection with FIGS. 1A and 1B, an updated graphical user interface 202 is presented on the client device 120 depicting multiple graphical indicators 234. In some implementations, the inflation game may involve interactions with multiple graphical indicators 234, shown here as balloons 234. This game mode can be provided as an alternative to the single balloon game. In this game mode, each of the graphical indicators 234 (e.g., a balloon in this example) can correspond to a respective wager. The number of balloons 234 can be predetermined based on the game instructions 180 or user preferences. In some implementations, the player can inflate each balloon 234 individually by pressing the corresponding press-and-hold button 236, as shown on the graphical user interface 202. The score for each balloon 234 may increase at the same rate, and the player can cash out for each balloon 234 individually or for all balloons 234 at once. In some implementations, the player can inflate all balloons 234 at the same time by pressing the single press-and-hold button 236. The score for all balloons 234 may increase at the same rate, and the player can cash out for all balloons at once.

The score for each balloon 234 can increase as the player interacts with the corresponding press-and-hold button 236 or the single press-and-hold button 236. The specific formula used to calculate the score increase may vary based on the game instructions 180, but it can generally be based on a linear or logarithmic relationship between the player's interaction with the button 236 and the score increase. For example, the score for each balloon 234 may be increased by a predetermined value (e.g., 1 point) each time the player interacts with the corresponding press-and-hold button 236 or the single press-and-hold button 236. In this example, the score would increase by the same amount for each balloon 234, regardless of which balloon 234 is being inflated. The player can cash out at any time to receive a payout based on the current score of each balloon 234. The payout can be proportional to the score of the balloon 234, so the higher the score, the greater the payout.

In some implementations, the rate at which the score for each balloon increases may be specific to the respective balloon 234. For example, the score for one balloon 234 may increase slower than the score for another balloon 234. In such implementations, each balloon 234 can be assigned a different predetermined rate at the start of the game. For example, one balloon 234 might have a score increase rate of 1 point per second, while another balloon might have a score increase rate of 2 points per second. In some implementations, the data processing system 105A can generate a score threshold for each of the balloons 234 (e.g., using a random number generator that generates numbers within a predetermined threshold range, randomly selecting from a table of thresholds, etc.). If the score of one or more of the balloons 234 exceeds the respective random score threshold, the data processing system 105A pops the respective balloon(s) 234. The data processing system 105A then updates the game state information 175 and the graphical user interface 202 to reflect the popped balloon(s). Each of the balloons 234 can have its own timer 240 that starts decrementing in response to the cessation of interaction with the press-and-hold button 236. In some implementations, there can be a single timer 240 for all the balloons 234.

In some implementations, the gameplay can include a multiplayer version where the graphical user interface 202 displays multiple balloons 234, each corresponding to a specific client device 120. The gameplay can include a predetermined number of rounds based on the game instructions 180. After each round, the data processing system 105A compares the score of each player to a predetermined score threshold. The data processing system 105A then updates the graphical user interface 202 to remove the balloons whose scores fall below the predetermined score threshold. The remaining players progress to the next round. This process continues until all balloons except one are left on the graphical user interface 202 (satisfying the termination condition in some implementations), upon which the graphical user interface 202 can be updated to display the winning player. The data processing system updates the credit balance of the player profile 170 accordingly.

In some implementations, the data processing system 105A can identify that a bonus condition has been satisfied based on the score of balloon 234 exceeding a predetermined threshold. Upon the bonus condition being satisfied, the data processing system 105A may provide one or more additional awards, including but not limited to an additional game play or a bonus award amount. In some implementations, the bonus threshold can be displayed to the player on the graphical user interface 202. The data processing system 105A can update the player profile 170 accordingly. The adjustment in the credit balance can be made based on the computed bonus award and the individual award amounts calculated for each outcome. In some implementations, the data processing system 105A can increase the credit balance in the player profile 170 by the sum of the bonus award amount and the award amount for each successful outcome. However, if the bonus award condition is not satisfied, resulting in a zero bonus award amount, the data processing system 105A can increase the credit balance only by the award amounts for the winning outcomes. In cases where the bonus award is credited to the player before the completion of the game, the data processing system 105A can update the credit balance of the player profile 170 by adding the award amounts for the winning outcomes to the credit balance.

Although the foregoing examples have been described in the context of the data processing system 105A and a client device 120, it should be understood that similar techniques may be performed using the data processing system 105B of FIG. 1B, which may be implemented as a standalone gaming console, kiosk, or machine. For example, rather than providing instructions to update the graphical user interface 202 at the client device 120, as in the foregoing examples, the data processing system 105B may display graphical user interfaces similar to those described in connection with FIGS. 2A-2F via the display device 185 and receive corresponding player interactions and wagers via the input device 160 and the wager receiver 165, respectively.

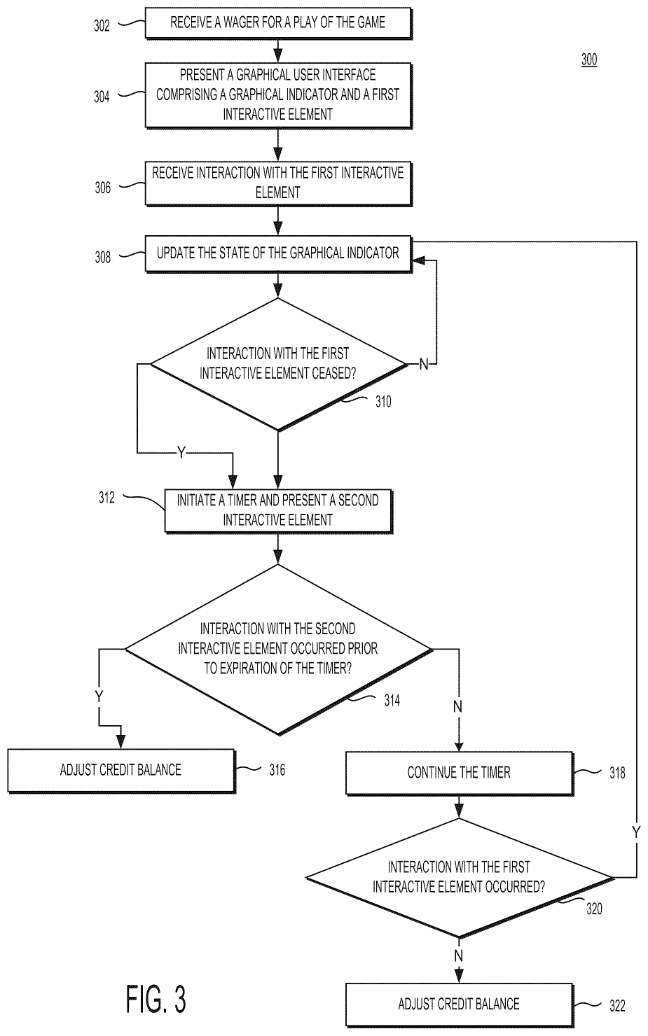

Referring now to FIG. 3, depicted is an illustrative flow diagram of a method 300 for providing a timed inflation game. The method 300 can be executed, performed, or otherwise carried out by a gaming server or a gaming system. A data processing system (e.g., the data processing system 105A, the data processing system 105B) can be remote to one to one or more client devices and communicate with the one or more client devices via a computer network. In some implementations, the operations of method 300 can be performed by a standalone gaming device (e.g., without communicating with a gaming server to perform the method steps, the data processing system 105B). In a brief overview of method 300, the gaming server can receive a wager (STEP 302), generate a graphical user interface having a graphical indicator and a first interactive element (STEP 304), receive interaction with the first interactive elements (STEP 306), update the state of the graphical indicator (STEP 308), determine whether the interaction with the first interactive element has ceased (STEP 310), initiate a timer and present a second interactive element if the interaction with the first interactive element has ceased (STEP 312), determine whether the interaction with the second interactive element has occurred prior to the expiration of the timer (STEP 314), adjust the credit balance if the interaction with the second interactive element has occurred (STEP 316), otherwise, continue the timer (STEP 318), determine whether the interaction with the first interactive element has occurred (STEP 320), and adjust the credit balance if the interaction with the first interactive element has occurred (STEP 322).

In further detail of method 300, the data processing system can receive a wager for a play of the game (STEP 302). The wager can be received in one or more messages received from a client device. The message, or request, can indicate that a player intends to play a game provided by the data processing system. The message can include an indication of a player profile with which to access functionalities related to the game (e.g., placing wagers using earned credits, purchasing additional credits, etc.). The wager can be provided via a graphical user interface (e.g., the graphical user interface of FIG. 2A). The wager amounts provided can be a specified amount of credits, such as 1, 5, 25, 100, 500, or 1000 credits. In some implementations, the player can specify a custom number or fractional number of credits used in the game. Once the wager has been selected, the client device can transmit a request to place the wagers for the play of the game.

Upon receiving the wager, the data processing system can generate a graphical user interface having a graphical indicator and a first interactive element (STEP 304). As shown in FIG. 2B, a graphical representation of a balloon is displayed with an interactive press-and-hold button on the graphical user interface. The balloon is shown as connected to the interactive press-and-hold button on the graphical user interface via a virtual string. In this example, the graphical indicator is shown as a balloon for illustrative purposes. However, in some implementations, the player can select different graphical indicator designs or shapes using a settings button, which updates the graphical user interface to a second graphical user interface that presents the selectable graphical indicators.

In some implementations, in response to receiving an interaction with the press-and-hold button (STEP 306), the data processing system updates the game state information and starts inflating the graphical representation of the balloon. The data processing system inflates the graphical representation of the balloon by increasing the size (or state) of the graphical representation of the balloon according to the increase in score (STEP 308). Inflation levels are a measure of how much the graphical representation of the balloon has been inflated. They can be represented by a number ranging from 0 to 1, where 0 (or any predefined endpoint) represents a completely deflated balloon and 1 (or any predefined endpoint) represents a fully inflated balloon. In some implementations, the inflation levels can be calculated based on the player's score. The data processing system continues to inflate the graphical representation of the balloon until the player releases the press-and-hold button.

A score for the balloon can be determined based on the wager selected and the multiplier values associated with different inflation levels. In some implementations, the score can be based on the start time of the play and the multiplier value associated with the inflation level at the time of cashing out, as described herein. In some implementations, the data processing system can associate a predetermined multiplier value (e.g., based on the game instructions) with the inflation of the balloon, and the multiplier value (or the computed score in general) can be used to determine how much the size of the graphical representation of the balloon increases each time the press-and-hold button is interacted with. Different multiplier values can be associated with different inflation levels. For example, a higher multiplier value can be associated with a higher inflation rate. The data processing system can dynamically adjust the multiplier value based on the player's performance or other factors. The graphical user interface and the corresponding game state information are updated every time the data processing system receives an interaction with the press-and-hold button. The graphical user interface is updated to display the current payout, corresponding to the current inflation level of the balloon. The current payout can be calculated based on the current inflation level of the balloon and the predetermined multiplier value associated with the inflation level.

When the data processing system identifies that the player has stopped interacting with the press-and-hold button (STEP 310), the graphical user interface is dynamically updated to present a cash out button and transform the press-and-hold button into a timer, as shown in connection with FIG. 2C (STEP 312). The timer begins to decrement from a predetermined expiration threshold (based on the game instructions or user preferences), effectively starting a countdown. As described herein, the graphical user interface is also updated to present the cash out button, with which the player can interact to manually cash out the current payout (STEP 316). In some implementations, the data processing system can continue the timer if the player has not interacted with the cash out button (STEP 318). If no interaction is received from the player (e.g., when the timer expires), the data processing system will automatically cash out the player (STEP 320). The player profile is updated accordingly (STEP 322).

In some implementations, the data processing system can update the graphical user interface and initiate inflating the balloon again (or updating the state of the balloon) if the data processing system receives an interaction with the timer before its expiration. Upon detecting such interaction, the graphical user interface is updated to transform the timer into the press-and-hold button. The graphical user interface can then be updated to remove the cash-out button in response to the interaction with the timer.

In some implementations, the data processing system can generate a random score threshold, which may be used to determine whether the player has lost the play of the game. In some implementations, the random score threshold can be predetermined prior to presenting the balloon on the graphical user interface. If, during the play of the game, the score is equal to or greater than the random score threshold, the data processing system can determine that the player has lost the play of the game and update the graphical user interface accordingly. In some implementations, the data processing system can determine the random score threshold based on a variety of factors, such as the game mode, the player's level, or the current score, among others. Once the balloon pops, the data processing system updates the game state information. The graphical user interface is also updated to display a pre-rendered animation of the balloon popping, which causes the data processing system to update the credit balance of the player profile. The graphical user interface is updated to transform the press-and-hold button into a non-interactive button, which restricts the ability of the player to further interact with the press-and-hold button. The data processing system updates the credit balance of the player profile accordingly. In some implementations, the termination condition (or the game condition in general) may correspond to a win condition that is satisfied when the score of the balloon, determined based on the initial wager and multiplier value associated with the inflation levels of the balloon, reaches a predetermined score threshold, as shown in connection with FIG. 2F.

In some implementations, the inflation game may involve interactions with multiple graphical indicators, shown here as balloons. This game mode can be provided as an alternative to the single balloon game. In this game mode, each of the graphical indicators (e.g., a balloon in this example) can correspond to a respective wager. The number of balloons can be predetermined based on the game instructions or user preferences. In some implementations, the player can inflate each balloon individually by pressing the corresponding press-and-hold button. The score for each balloon may increase at the same rate, and the player can cash out for each balloon individually or for all balloons at once. In some implementations, the player can inflate all balloons at the same time by pressing the single press-and-hold button. The score for all balloons may increase at the same rate, and the player can cash out for all balloons at once. The score for each balloon can increase as the player interacts with the corresponding press-and-hold button or the single press-and-hold button. The specific formula used to calculate the score increase may vary based on the game instructions, but it can generally be based on a linear or logarithmic relationship between the player's interaction with the button and the score increase.

In some implementations, the gameplay can include a multiplayer version where the graphical user interface displays multiple balloons, each corresponding to a specific client device. The gameplay can include a predetermined number of rounds based on the game instructions. After each round, the data processing system compares the score of each player to a predetermined score threshold. The data processing system then updates the graphical user interface to remove the balloons whose scores fall below the predetermined score threshold. The remaining players progress to the next round. This process continues until all balloons except one are left on the graphical user interface (satisfying the termination condition in some implementations), upon which the graphical user interface can be updated to display the winning player. The data processing system updates the credit balance of the player profile accordingly.

In some implementations, the data processing system can identify that a bonus condition has been satisfied based on the score of balloon exceeding a predetermined threshold. Upon the bonus condition being satisfied, the data processing system may provide one or more additional awards, including but not limited to an additional game play or a bonus award amount. In some implementations, the bonus threshold can be displayed to the player on the graphical user interface. The data processing system can update the player profile accordingly. The adjustment in the credit balance can be made based on the computed bonus award and the individual award amounts calculated for each outcome. In some implementations, the data processing system can increase the credit balance in the player profile by the sum of the bonus award amount and the award amount for each successful outcome. However, if the bonus award condition is not satisfied, resulting in a zero bonus award amount, the data processing system can increase the credit balance only by the award amounts for the winning outcomes. In cases where the bonus award is credited to the player before the completion of the game, the data processing system can update the credit balance of the player profile by adding the award amounts for the winning outcomes to the credit balance.

Various operations described herein can be implemented on computer systems. FIG. 4 shows a simplified block diagram of a representative server system 400, client computer system 414, and network 426 usable to implement certain embodiments of the present disclosure. In various embodiments, server system 400 or similar systems can implement services or servers described herein or portions thereof. Client computer system 414 or similar systems can implement clients described herein. The system (e.g., the data processing system 105A) and others described herein can be similar to the server system 400.

Server system 400 can have a modular design that incorporates a number of modules 402; while two modules 402 are shown, any number can be provided. Each module 402 can include processing unit(s) 404 and local storage 406.

Processing unit(s) 404 can include a single processor, which can have one or more cores, or multiple processors. In some embodiments, processing unit(s) 404 can include a general-purpose primary processor as well as one or more special-purpose co-processors such as graphics processors, digital signal processors, or the like. In some embodiments, some or all processing units 404 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 404 can execute instructions stored in local storage 406. Any type of processors in any combination can be included in processing unit(s) 404.

Local storage 406 can include volatile storage media (e.g., DRAM, SRAM, SDRAM, or the like) and/or non-volatile storage media (e.g., magnetic or optical disk, flash memory, or the like). Storage media incorporated in local storage 406 can be fixed, removable or upgradeable as desired. Local storage 406 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 404 need at runtime. The ROM can store static data and instructions that are needed by processing unit(s) 404. The permanent storage device can be a non-volatile read-and-write memory device that can store instructions and data even when module 402 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 406 can store one or more software programs to be executed by processing unit(s) 404, such as an operating system and/or programs implementing various server functions such as functions of the data processing system 105A of FIG. 1A or any other system described herein, or any other server(s) associated with the data processing system 105A, or any other system described herein.

“Software” refers generally to sequences of instructions that, when executed by processing unit(s) 404 cause server system 400 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 404. Software can be implemented as a single program or a collection of separate programs or program modules that interact as desired. From local storage 406 (or non-local storage described below), processing unit(s) 404 can retrieve program instructions to execute and data to process in order to execute various operations described above.

In some server systems 400, multiple modules 402 can be interconnected via a bus or other interconnect 408, forming a local area network that supports communication between modules 402 and other components of server system 400. Interconnect 408 can be implemented using various technologies including server racks, hubs, routers, etc.

A wide area network (WAN) interface 410 can provide data communication capability between the local area network (interconnect 408) and the network 426, such as the Internet. Technologies can be used, including wired (e.g., Ethernet, IEEE 802.3 standards) and/or wireless technologies (e.g., Wi-Fi, IEEE 802.11 standards).

In some embodiments, local storage 406 is intended to provide working memory for processing unit(s) 404, providing fast access to programs and/or data to be processed while reducing traffic on interconnect 408. Storage for larger quantities of data can be provided on the local area network by one or more mass storage subsystems 412 that can be connected to interconnect 408. Mass storage subsystem 412 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 412. In some embodiments, additional data storage resources may be accessible via WAN interface 410 (potentially with increased latency).

Server system 400 can operate in response to requests received via WAN interface 410. For example, one of modules 402 can implement a supervisory function and assign discrete tasks to other modules 402 in response to received requests. Work allocation techniques can be used. As requests are processed, results can be returned to the requester via WAN interface 410. Such operation can generally be automated. Further, in some embodiments, WAN interface 410 can connect multiple server systems 400 to each other, providing scalable systems capable of managing high volumes of activity. Techniques for managing server systems and server farms (collections of server systems that cooperate) can be used, including dynamic resource allocation and reallocation.

Server system 400 can interact with various user-owned or user-operated devices via a wide-area network such as the Internet. An example of a user-operated device is shown in FIG. 4 as client computing system 414. Client computing system 414 can be implemented, for example, as a consumer device such as a smartphone, other mobile phone, tablet computer, wearable computing device (e.g., smart watch, eyeglasses), desktop computer, laptop computer, and so on.

For example, client computing system 414 can communicate via WAN interface 410. Client computing system 414 can include computer components such as processing unit(s) 416, storage device 418, network interface 420, user input device 422, and user output device 424. Client computing system 414 can be a computing device implemented in a variety of form factors, such as a desktop computer, laptop computer, tablet computer, smartphone, other mobile computing device, wearable computing device, or the like.

Processing unit(s) 416 and storage device 418 can be similar to processing unit(s) 404 and local storage 406 described above. Suitable devices can be selected based on the demands to be placed on client computing system 414; for example, client computing system 414 can be implemented as a “thin” client with limited processing capability or as a high-powered computing device. Client computing system 414 can be provisioned with program code executable by processing unit(s) 416 to enable various interactions with server system 400 of a message management service such as accessing messages, performing actions on messages, and other interactions described above. Some client computing systems 414 can also interact with a messaging service independently of the message management service.

Network interface 420 can provide a connection to the network 426, such as a wide area network (e.g., the Internet) to which WAN interface 410 of server system 400 is also connected. In various embodiments, network interface 420 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 422 can include any device (or devices) via which a user can provide signals to client computing system 414; client computing system 414 can interpret the signals as indicative of particular user requests or information. In various embodiments, user input device 422 can include any or all of a keyboard, touch pad, touch screen, mouse or other pointing device, scroll wheel, click wheel, dial, button, switch, keypad, microphone, and so on.

User output device 424 can include any device via which client computing system 414 can provide information to a user. For example, user output device 424 can include a display to display images generated by or delivered to client computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 424 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 404 and 416 can provide various functionality for server system 400 and client computing system 414, including any of the functionality described herein as being performed by a server or client, or other functionality associated with message management services.

It will be appreciated that server system 400 and client computing system 414 are illustrative and that variations and modifications are possible. Computer systems used in connection with embodiments of the present disclosure can have other capabilities not specifically described here. Further, while server system 400 and client computing system 414 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the gaming system described herein can include clients and servers. For example, the gaming system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the gaming system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from their characteristics thereof. Although the examples provided may be useful for providing timed inflation games, the systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

What is claimed is:

1. A system, comprising:
one or more processors coupled to non-transitory memory, the one or more processors configured to:
receive a wager for a play of a game;
responsive to receiving the wager, cause presentation of a graphical user interface comprising:
a graphical indicator representing a score for the play of the game; and
a first interactive element that, when interacted with, is configured to cause the score for the play of the game to be updated;
responsive to a first interaction with the first interactive element, update a state of the graphical indicator to increase the score for the play of the game;
responsive to determining that the first interaction with the first interactive element has ceased:
initiate a timer to count passage of time to an expiration threshold; and
cause the graphical user interface to present a second interactive element that, when interacted with, causes the play of the game to terminate; and
responsive to a second interaction with the second interactive element prior to an expiration of the timer, adjust a credit balance based on the wager and the score of the play of the game.

2. The system of claim 1, wherein the one or more processors are further configured to cause the graphical user interface to reset the timer responsive to a third interaction with the first interactive element.

3. The system of claim 1, wherein the one or more processors are further configured to cause the graphical user interface to present a plurality of graphical indicators, each graphical indicator of the plurality of graphical indicators corresponding to a respective wager.

4. The system of claim 3, wherein each graphical indicator of the plurality of graphical indicators is associated with a respective indicator score, and wherein the one or more processors are further configured to:
generate a respective random score threshold for each graphical indicator of the plurality of graphical indicators;
identify a first subset of the plurality of graphical indicators having the respective indicator score greater than the respective random score threshold; and
update the graphical user interface based on the respective indicator score of each graphical indicator of the first subset of the plurality of graphical indicators.

5. The system of claim 4, wherein the one or more processors are further configured to:
select a second subset of the plurality of graphical indicators having the respective indicator score less than the respective random score threshold, the second subset including the graphical indicator; and
adjust the credit balance based on the respective wager and the respective indicator score of each graphical indicator of the second subset of the plurality of graphical indicators responsive to termination of the play of the game.

6. The system of claim 4, wherein the one or more processors are further configured to cause the graphical user interface to generate a respective interactive element for each graphical indicator of the plurality of graphical indicators responsive to determining that the first interaction with the first interactive element has ceased, the respective interactive element, when interacted with, causing the one or more processors to adjust the credit balance based on the respective indicator score of the graphical indicator of the plurality of graphical indicators to which the respective interactive element corresponds.

7. The system of claim 1, wherein the one or more processors are further configured to increase a size of the graphical indicator based on the score of the play of the game.

8. The system of claim 1, wherein the one or more processors are further configured to:
determine that a bonus condition has been satisfied responsive to the score for the play of the game exceeding a threshold; and
adjust the credit balance responsive to determining that the bonus condition has been satisfied.

9. The system of claim 1, wherein the one or more processors are further configured to:
receive a second wager for a second play of the game;
responsive to receiving the second wager, cause presentation of a second graphical user interface for the second play of the game, the second graphical user interface comprising a second graphical indicator, the second graphical indicator corresponding to a second indicator score;
update the second indicator score responsive to the first interaction with the first interactive element; and
responsive to determining that the second indicator score exceeds a random score threshold, generate a notification for display, the notification indicating the second wager for the second play of the game has been lost.

10. The system of claim 1, wherein the one or more processors are further configured to adjust the expiration threshold of the timer based on a user selection.

11. A method, comprising:
receiving, by one or more processors coupled to non-transitory memory, a wager for a play of a game;
responsive to receiving the wager, causing, by the one or more processors, presentation of a graphical user interface comprising:
a graphical indicator representing a score for the play of the game; and
a first interactive element that, when interacted with, is configured to cause the score for the play of the game to be updated;
responsive to a first interaction with the first interactive element, updating, by the one or more processors, a state of the graphical indicator to increase the score for the play of the game;
responsive to determining that the first interaction with the first interactive element has ceased:
initiating, by the one or more processors, a timer to count passage of time to an expiration threshold; and
causing, by the one or more processors, the graphical user interface to present a second interactive element that, when interacted with, causes the play of the game to terminate; and
responsive to a second interaction with the second interactive element prior to an expiration of the timer, adjusting, by the one or more processors, a credit balance based on the wager and the score of the play of the game.

12. The method of claim 11, further comprising causing, by the one or more processors, the graphical user interface to reset the timer responsive to a third interaction with the first interactive element.

13. The method of claim 11, further comprising causing, by the one or more processors, the graphical user interface to present a plurality of graphical indicators, each graphical indicator of the plurality of graphical indicators corresponding to a respective wager.

14. The method of claim 13, wherein each graphical indicator of the plurality of graphical indicators is associated with a respective indicator score, further comprising:
generating, by the one or more processors, a respective random score threshold for each graphical indicator of the plurality of graphical indicators;
identifying, by the one or more processors, a first subset of the plurality of graphical indicators having the respective indicator score greater than the respective random score threshold; and
updating, by the one or more processors, the graphical user interface based on the respective indicator score of each graphical indicator of the first subset of the plurality of graphical indicators.

15. The method of claim 14, further comprising:
selecting, by the one or more processors, a second subset of the plurality of graphical indicators having the respective indicator score less than the respective random score threshold, the second subset including the graphical indicator; and
adjusting, by the one or more processors, the credit balance based on the respective wager and the respective indicator score of each graphical indicator of the second subset of the plurality of graphical indicators responsive to termination of the play of the game.

16. The method of claim 14, further comprising causing, by the one or more processors, the graphical user interface to generate a respective interactive element for each graphical indicator of the plurality of graphical indicators responsive to determining that the first interaction with the first interactive element has ceased, the respective interactive element, when interacted with, causing the one or more processors to adjust the credit balance based on the respective indicator score of the graphical indicator of the plurality of graphical indicators to which the respective interactive element corresponds.

17. The method of claim 11, further comprising increasing, by the one or more processors, a size of the graphical indicator based on the score of the play of the game.

18. The method of claim 11, further comprising:
determining, by the one or more processors, that a bonus condition has been satisfied responsive to the score for the play of the game exceeding a threshold; and
adjusting, by the one or more processors, the credit balance responsive to determining that the bonus condition has been satisfied.

19. The method of claim 11, further comprising:
receiving, by the one or more processors, a second wager for a second play of the game;
responsive to receiving the second wager, causing, by the one or more processors, presentation of a second graphical user interface for the second play of the game, the second graphical user interface comprising a second graphical indicator, the second graphical indicator corresponding to a second indicator score;
updating, by the one or more processors, the second indicator score responsive to the first interaction with the first interactive element; and
responsive to determining that the second indicator score exceeds a random score threshold, generating, by the one or more processors, a notification for display, the notification indicating the second wager for the second play of the game has been lost.

20. The method of claim 11, further comprising adjusting, by the one or more processors, the expiration threshold of the timer based on a user selection.
